(19) United States
(12) Patent Application Publication
(10) Pub. No.: US 2008/0215681 A1
(43) Pub. Date: Sep. 4, 2008

(54) NETWORK ARCHITECTURE FOR MULTI-USER COLLABORATION AND DATA-STREAM MIXING AND METHOD THEREOF

(76) Inventors: Thomas Darcie, Victoria (CA); Neil Barakat, Victoria (CA)

Correspondence Address: MALDJIAN & FALLON LLC, 365 BROAD ST. , 3RD FLOOR, RED BANK, NJ, 07701, US

(21) Appl. No.: 12/024,831

(22) Filed: Feb. 1, 2008

Related U.S. Application Data
(63) Continuation-in-part of application No. 11/740,794, filed on Apr. 26, 2007.
(60) Provisional application No. 60/796,396, filed on May 1, 2006.
(60) Provisional application No. 60/887,784, filed on Feb. 1, 2007.

(51) Int. Cl. G06F 15/16

(52) U.S. Cl. 709/204

(57) ABSTRACT

Embodiments of the present invention generally relate to a system and method for selecting the best server to realize the best user-experience for the client. The selection of this server is selected based on the quality of each user's connection to each server. Embodiments of the present invention also generally relate to a system and method to facilitate efficient transmission and carry each user's stream to the selected server.

### CROSS-REFERENCE TO RELATED APPLICATIONS

This application is a continuation-in-part of U.S. patent application Ser. No. 11/740,794, filed Apr. 26, 2007, entitled “System and Method for Processing Data Signals,” which claims its earliest benefit to U.S. Provisional Patent Application Ser. No. 60/796,396, filed May 1, 2006, entitled “System and Method for Transmitting Audio Signals,” the disclosures of which are incorporated herein by reference in their entireties. This application also claims the benefit of U.S. Provisional Patent Application Ser. No. 60/887,784, filed Feb. 1, 2007, entitled “Network Architecture for Multi-User Collaboration and Data-Stream Mixing and Method Thereof,” which is incorporated herein by reference in its entirety.

### BACKGROUND

1. Field of the Invention

Embodiments of the present invention are generally related to network architecture. More specifically, embodiments of the present invention relate to network architecture for multi-user collaboration and data-stream mixing and a method thereof method.

2. Description of the Related Art

FIG. 1 and FIG. 2 illustrate known challenges in the industry. In FIG. 1, a network is shown with multiple servers and multiple users. A plurality of users may wish to connect to collaborate with each other, which requires their data streams be transmitted to, and mixed at, a single server. In general, each server will result in a different quality of user experience based on, for example, the transmission delay between the server and each of the users. Thus, the decision of which server to select is not trivial.

Known methods for interconnecting users and applications through interconnected IP networks (e.g., the Internet) involve routing through a predefined set of interconnections. These interconnections or peering points are generally not visible to end users and application providers, and are subject to wide variations in performance. In addition, actual routing paths taken are unpredictable, such that geographically close users may be peered through distant peering points. As a result, would-be providers of delay-sensitive applications are inhibited by high delay and variability.

While many current Internet applications are insensitive to the additional about 50-100 msec delay encountered at typical peering points, such delays are intolerable for many delay-sensitive services include online gaming, online music collaboration, online networking, and the like.

Delay in packet networks has been the subject of intense activity by researchers, equipment vendors, and telecommunications service providers. However, emphasis has been on managing delay within a given carriers' domain. These intra-domain solutions may include, for example, Multiprotocol Label Switching (MPLS), in which a path is defined for pre-specified data flows, and these paths are given express treatment through the network of routers using rapid label switching. The main drawback to MPLS is complexity. Prior to the standardization of MPLS, a host of quality-of-service (QoS) mechanisms were built into networking standards, including integrated services (Intserve) and differentiated services (Diffserve). These have been incorporated into virtual local area network (VLAN) standards and extended across local and metro area networks to provide specific priority paths, but generally do not scale to Internet-scale numbers of distributed users. Layer 2 Asynchronous Transfer Mode (ATM) switching also offered strict performance bounds and ultimately deterministic QoS. However, this involves prior definition of virtual circuits, a cumbersome, inflexible, and management-intensive operation that drove ATM out of favor relative to layer 3 IP router-based approaches.

The intra-domain performance of IP networks is not necessarily the problem. Delay encountered in peering between carrier networks operated by different carriers, rather, is a major problem. Peering, or the mutual exchange of IP traffic, occurs regularly in transit between typical sources and destinations. Common practice for peering involves the negotiation of bandwidth exchange between routers, with throughput mediated by a border gateway protocol (BGP). Unfortunately, BGP provides only best-effort routing between peered domains. Hence the peering can undermine any individual carriers' management of QoS for inter-domain applications. Thus, internetworking peering has been recognized as a major obstacle to providing end-to-end QoS guarantees to connections.

FIG. 2 illustrates an additional difficulty associated with the quality of connections. Users connect through their computer to an access provider (usually cable or DSL). Access providers, after routing through their regional networks (shown as access clouds), connect to other wide area networks. The broken line illustrates the resultant suboptimal and not controlled path taken by data communication.

The problem of selecting the best server at which to provide service to a single user is a common problem in the Internet. The most widespread example is in content delivery networks (CDNs) in which the content (e.g., web pages, or multimedia files) of a service provider is copied or ‘cached’ at numerous servers around the Internet. When users request to download content, they are automatically pointed/connected to the best (e.g. closest) server that contains the content they desire. Similarly, many distributed service networks, such as online gaming may have a similar approach—a user who wishes to connect to a game server may be directed to the best or closest server.

It has been previously recognized that packets transmitted over the Internet can incur unpredictable, variable delay and loss due to congestion in the network and the best-effort nature of Border Gateway Protocol (BGP) peering between ISP domains. Overlay networks address this problem. An overlay network is a computer network constructed on top of another network, usually by placing a number of nodes (servers) throughout the larger network and leasing dedicated (pre-provisioned) links between these nodes.

In certain applications, users require low latency to react to other users' actions, for example, in online gaming. However, in general, delays of over 100 msec are tolerable, as game designers offer redundancy in the form of, for example, many bullets fired in rapid succession. Also, users quickly become skilled in anticipation, for example by leading a target with a shot, having learned the effect of typical delay. Thus, the delay constraint for certain types of games can be relaxed by judicious game design and by leveraging the ability of the users' adaptability. Some games involve direct reaction to an opponent's move, such as a thrown punch. Since anticipation is not possible, and singular events cannot be missed, no satisfactory means exist to support these games on existing wide-area networks.

Delay has long been recognized as a key impediment for on-line music collaboration. As a result, several solutions have been attempted. For example, one solution is to add delay to each musician such that all musicians hear a synchronized but late performance. Unfortunately, adding delay detracts from the real-time experience, making it difficult for musicians to perform. It has been demonstrated that musical collaboration can be accomplished over point-to-point networks of limited extent. However, collaboration over a distance and through peering points remains unproven. Previous demonstrations of long-distance collaboration have relied on special research networks that are free from inter-domain peering typical of today's Internet.

Thus, there is a need for a method for selecting the best server to realize the best user-experience for the clients. The selection of this server will generally be selected based on the quality of each user's connection to each server. Since this quality can be quite poor and quite unpredictable in today's Internet, there is also a need for a method to facilitate efficient transmission and carry each user's stream to the selected server. These two needs are inter-related (e.g., solution of the latter may affect the former).

### SUMMARY

In one embodiment, methods for mixing multimedia streams on a remote server on a network and distributing the resulting mix(es) to the users is provided. In another embodiment, a method for selecting the best, or better, location at which to mix the multimedia streams is provided. In another embodiment, an architecture by which data streams can be efficiently forwarded between the users and the servers is provided.

In another embodiment, overlay networks control the path that packets take through a parent network.

Many embodiments of the present invention relate to real-time online collaboration services, where the objective is to provide users access to each other or to bring together and mix users' streams. In one embodiment, computing a cost function including all users' connection quality to each server, their service requirements, and the state of each server is utilized to enhance real-time or near real-time audio collaboration. In such an embodiment, the cost could be based on a number of factors, such as latency, bandwidth, server business, or the like, and the server that results in the lowest cost could be chosen to connect the users.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts one embodiment of a server selection problem associated with the prior art;

FIG. 2 depicts one embodiment of an unpredictable path problem associated with the prior art;

FIG. 3 depicts a block diagram of a general computer system in accordance with one embodiment of the present invention;

FIG. 4 depicts a block diagram of a system in accordance with one embodiment of the present invention; and

FIG. 5 depicts a block diagram of a system in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to network architecture. More specifically, embodiments of the present invention relate to network architecture for multi-user collaboration and data-stream mixing and a method thereof method.

Embodiments of the present invention are generally related to a method and apparatus for mixing a data signal. More specifically, embodiments of the present invention relate to a method and apparatus for mixing a data signal in a frequency domain so as to realize computational efficiency and reduced latency.

FIG. 3 depicts a block diagram of a general computer system in accordance with one embodiment of the present invention. The computer system 100 generally comprises a computer 102. The computer 102 illustratively comprises a processor 104, a memory 110, various support circuits 108, an I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. The storage system 111 may comprise any type of block-based storage device or devices, such as a disk drive system.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read only memory, magneto-resistive read/write memory, optical read/write memory, cache memory, magnetic read/write memory, and the like.

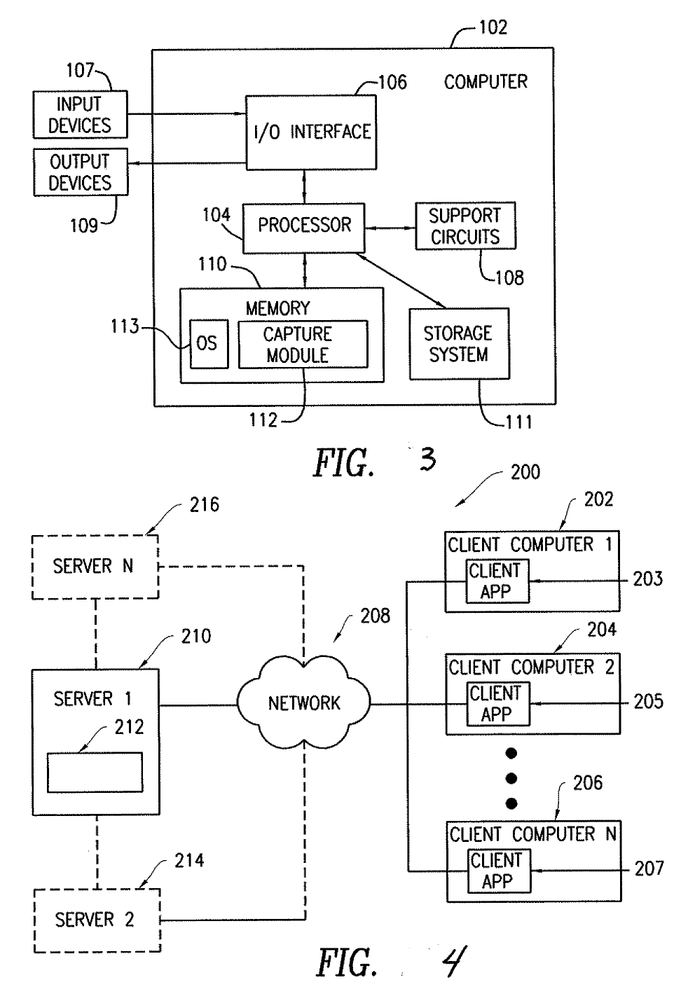

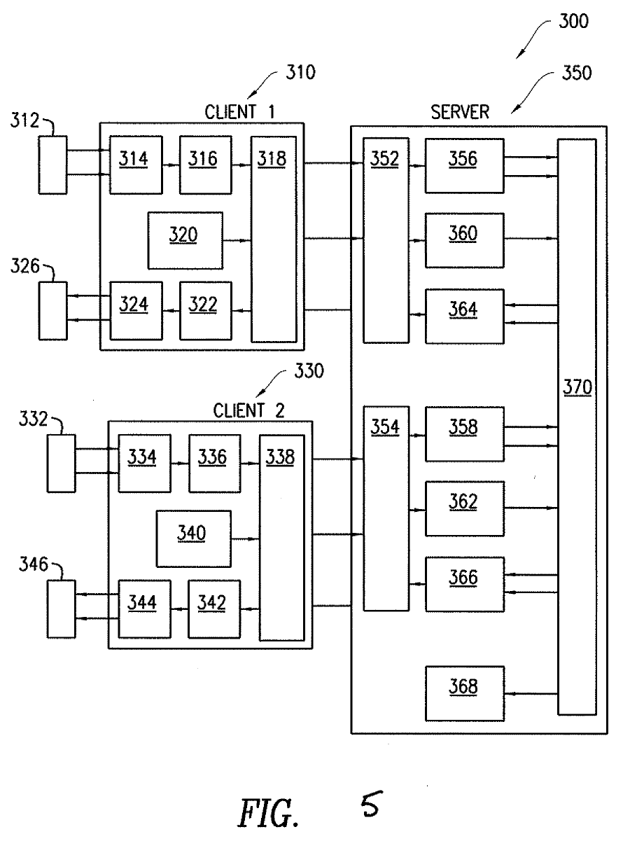

FIG. 4 depicts a block diagram of a system in accordance with one embodiment of the present invention. The system 200 depicted in FIG. 2, is described in detail in related U.S. patent application Ser. No. 11/740,794, published as U.S. Patent Application Publication No. 2007/0255816, the disclosure of which is incorporated herein by reference in its entirety. As understood by embodiments of the present invention, such systems, as disclosed by the referenced application publication, may support the methods and apparatus disclosed herein.

The system 200 generally comprises a first client computer 202, a second client computer 204, and additional client computers, up to client computer N 206, where N represents any number of client computers practical for operation of embodiments of the present invention. The system 200 further includes a network 208, a server 210, a mixer 212, and optionally a plurality of N additional servers (e.g., 214 & 216). The network 208 may be any network suitable for embodiments of the present invention, including, but not limited to, a global computer network, an internal network, local-area networks, wireless networks, and the like.

The first client computer 202 comprises a client application 203. The client application 203 is generally software or a similar computer-readable medium capable of at least enabling the first client computer 202 to connect to the proper network 208. In one embodiment, the client application 203 is software, commercially available by Lightspeed Audio Labs of Tinton Falls, N.J. In another embodiment, the client application 203 further provides instructions for various inputs (not shown), both analog and digital, and also provides instructions for various outputs (not shown), including a speaker monitor (not shown) or other output device. The second client computer 204 and client computer N 206 also comprise respective client applications (205, 207).

The server 210 may be any type of server, suitable for embodiments of the present invention. In one embodiment, the server 210 is a network-based server located at some remote destination (i.e., a remote server). In other embodiments, the server 210 may be hosted by one or more of the client computers. Additional embodiments of the present invention provide the server 210 is located at an internet service provider or other provider and is capable of handling the transmission of multiple clients at any given time.

The server 210 may also comprise a server application (not shown). The server application may comprise software or a similar computer-readable medium capable of at least allowing clients to connect to a proper network. In one embodiment, the server application is software, commercially available by Lightspeed Audio Labs of Tinton Falls, N.J. Optionally, the server application may comprise instructions for receiving data signals from a plurality of clients, compiling the data signals according to unique parameters, and the like.

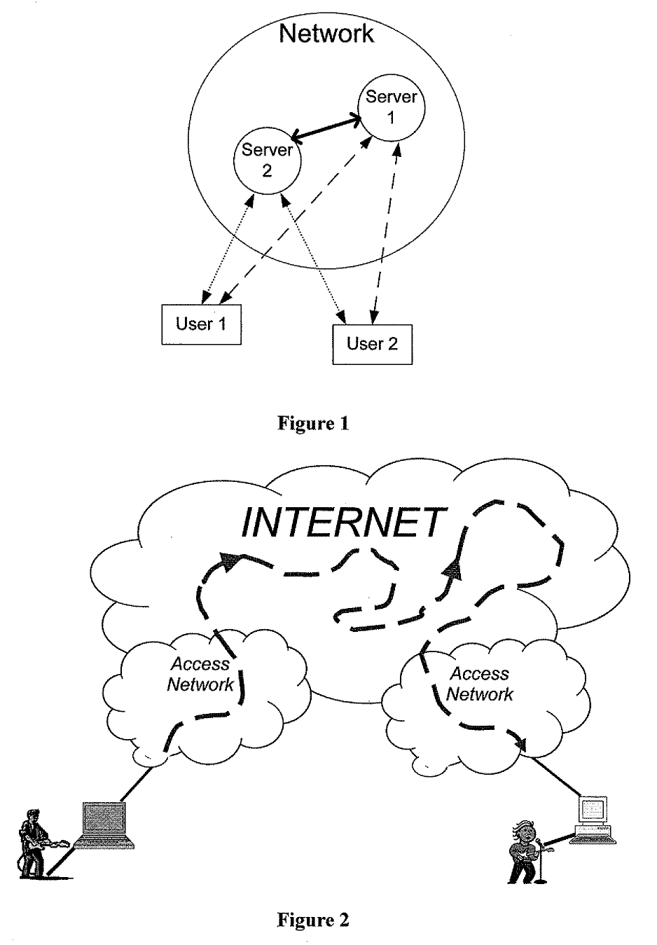

The mixer 212 may be any mixing device capable of mixing, merging, or combining a plurality of data signals at any one instance. In one embodiment, the mixer is a generic computer, as depicted in FIG. 1. In another embodiment, the mixer 212 is capable of mixing a plurality of data signals, in accordance with a plurality of different mixing parameters, resulting in various unique mixes. The mixer 212 is generally located at the server 210 in accordance with some embodiments of the present invention. Alternative embodiments provide the mixer 212 located at a client computer, independent of server location.

As is understood by one of ordinary skill in the art, multiple servers may be the most efficient methods of communication between multiple clients when particular constraints exist. In one embodiment, multiple servers are provided to support multiple clients in a particular session. For example, in one embodiment, a group of three clients are connected through a first server 210 for a first session. A group of five clients want to engage in a second session, but the first server 210 is near capacity. The group of five clients are then connected through the second server 214 to allow for a session to take place.

For example, in another embodiment, a server 210 hosting a mixer 212 is provided in a system 200. As the server 210 becomes congested with multiple client transmissions, it may be beneficial to allow some of the clients to pass through a second server 214, thus relieving the bandwidth on the server 210. The second server 214 and first server 210 may be connected to one another through the network and/or any other known communication means to provide the most efficient methods of communication. If necessary, additional server N 216, where N represents any number of servers practical for operation of embodiments of the present invention, may be utilized as well.

FIG. 5 depicts a block diagram of a system in accordance with one embodiment of the present invention. The system 300 generally comprises at least a first client 310, a second client 330, and a server 350. Optionally, a plurality of additional clients (not shown) or servers (not shown) may be provided without deviating from the structure of embodiments of the present invention.

In one embodiment, the first client 310 comprises an input device 312, an output device 326, and an interface 318 for connecting to the server 350. The first client 310 may also comprise an input sample rate converter 314, audio encoder 316, audio decoder with error mitigation 322, and output sample rate converter 324. Optionally, the first client 310 comprises a mix controller 320 having a graphical user interface.

The input device 312 comprises at least one of any musical instrument (e.g., guitar, drums, bass, microphones, and the like), other live or pre-recorded audio data (e.g., digital audio, compact disc, cassette, streaming radio, live concert, voice(s)/vocal(s), and the like), live or pre-recorded visual data, (e.g., webcam, pre-recorded video, and the like), other multimedia data, and the like. The output device 326 comprises at least one of headphones, speaker(s), video monitor, recording device (e.g., CD/DVD burner, digital sound recorder, and the like), means for feeding to other location, and the like.

The second client 330 similarly comprises an input device 332, an output device 346, an interface 338 for communicating with the server 350, an input sample rate converter 334, audio encoder 336, audio decoder with error mitigation 342, and output sample rate converter 344. Optionally, the second client 330 comprises a mix controller 340 having a graphical user interface. The input device 332 and output device 346 are substantially similar to the first client input device 312 and output device 332, respectively.

The server 350 generally comprises a first interface 352 for communicating with the first client 310, a second interface 354 for communicating with the second client 330, and a mixer 370. The server 350 may also comprise a first and second audio decoder with error mitigation 356, 358, a first and second controller for processing mix parameter instructions 360, 362, a first and second audio encoder 364, 366, and a status console 368. The status console 368 provides a visual and/or audio indication of the status of the system 300, at any given time during operation.

The mixer 370 is provided to perform the mix of multiple client data signals into single, stereo, or multi-channel signals (e.g., 5.1 Channel Sound). For audio signals, a mix is generally understood as the addition or blending of wave forms. The mixer 370 generally comprises a plurality of input and output channels, equal to at least the number of clients communicating with the server 350 at any given time.

In one embodiment, at the server 350, an executable program coordinates the transmission of compressed audio and control data over an IP channel between at least the first client 310 and server 350 and also coordinates similar audio-related routines. In such an embodiment, the server 350 audio decoder 356 receives compressed audio from the client 310 and reproduces the data signals (e.g., instrument and voice signals) and presents these to the mixer 370. Another server 350 module receives mix control parameters from the client 310 and presents them to the mixer 370. The server 350 audio encoder 364 receives the mixed stereo signal associated with a given client 310, compresses it, and presents it to the IP interface 352 for transmission to the client 310.

In some embodiments of the present, connectivity is provided to a plurality of users, for example two, who are connecting to a single server for online collaboration. In a first step, a ‘best’ available server is determined, and then the best connectivity to the server is determined, for each user.

In other embodiments of the present invention, multiple servers exist, providing a similar function in a common network, and in which the service may prefer that multiple users be inter-connected via a single server. For example, online music collaboration, online multi-player gaming, and video conferencing, may be performed via this embodiment.

In some embodiments, a plurality of users (e.g., two users) wish to collaborate online and must do so via a single server. For example, in online music collaboration, the server may provide a mixing operation and then send the mixed stream(s) back to each user. In one embodiment, there are (at least) two servers in the network that can be reached from each user.

In some embodiments, the design of a network architecture that ensures that the best connection can be made between all users and one of the available application servers, and the judicious operation of said network. In such embodiments, this operation may include, among other things, three components: (1) a method for determining the cost/benefit of using each server to connect the users; (2) determining which is the best server at which to provide service, and (3) determining how each user is to be connected to the chosen server.

In many embodiments, all three of the above-listed components are inter-related. As such, the order in which they are performed may vary depending on the particular system. Alternatively, in other embodiments, given this interdependency, all three listed components may be listed simultaneously.

In some embodiments, the cost associated with using a server may depend on a number of different factors including the quality of the connection between each user and the server (e.g., latency, jitter, bandwidth, packet loss probability, security, and the like.), and the state of each server (e.g. how busy is the server at present). In one embodiment, the cost can either be determined based on static system parameters, such as the users' geographical distance from a particular server, or based on dynamic measurements performed each time a group of users want to initiate a session. For example, dynamic measurements may be done by probing the path between the user and each server with test packets to determine delay, loss, or the like, or by polling the server to determine its load at session initiation time. Various techniques may be used for a polling process. For example, Internet Control Message Protocol (ICMP) echo request/reply (‘ping’) messages can be exchanged between the users and the servers to measure round-trip delay.

In one embodiment, once the cost of connecting each user to each server is determined, the server with the least overall cost is selected. In such an embodiment, the ‘overall cost’ of a given server is determined by combining the corresponding individual costs of each user. In another embodiment, the method of combination may vary depending on the application. In collaborative applications, an approach that minimizes average cost or a ‘best-worst’ (also known as ‘min-max’) approach may be warranted. For example, in an online music collaboration scenario, latency is an important issue. Thus, in such an embodiment, one might wish to select the server such that the latency of the worst users (in terms of latency) is minimized with the motivation that one bad user can disrupt the entire session. Alternatively, in another embodiment, the server that results in the minimum average latency may be best. In competitive applications, it might be better to select a server that results in the fairest cost distribution among users. For instance, in an online gaming scenario in which users compete against each other, a user may have an advantage by being connected over a better link to the server, so the server to which all users in the session have the most similar-quality path should be selected.

In another embodiment, assuming that a given server has been selected, all users then connect to that server. In general, there may be many paths between a user and the selected server, so the path of minimal cost should be selected for each user. Depending on the cost metric used in the server selection, the selection of the ‘best’ path may affect the decision on which server should host the clents' session.

In other embodiments, assuming that there is a link between each server, one method to provide an alternate path is to have a client transmit its stream (i.e. packets) to one server and to have that server reroute the packets to the final destination server that will be providing the service. Thus, in a network with N nodes, each user might have at least N−1 different paths to a particular target server.

Embodiments utilizing relay nodes provide path diversity to the users, which makes the network more robust to failures and provides a natural mechanism for load balancing. Furthermore, by leasing high-quality inks between the servers, one may achieve high-quality robust communication between servers. Given the unpredictable nature of the Internet, embodiments utilizing a relay-node architecture provides a mechanism for a client to address the server ‘closest’ to it to minimize the distance that must be traversed over the Internet.

In other embodiments, an alternate means is required for the relaying server to differentiate such packets from other packets whose final destination is the relay-server itself, since packets arriving at a server to be relayed to another server will have the first server's IP address in their address field. In some embodiments, this can be achieved by dynamically configuring the relay node upon session initiation time, for example, to use the source IP address of arriving packets to determine that they belong to a client stream destined for another server. Alternatively, in other embodiments, the relay-server can examine the contents of arriving packets to determine their final destination, although this may be a processor intensive approach for high packet rates. Also, in other embodiments, a field in the IP packet other than the destination address could be used to signal to a server that it is to relay the packet to another server (e.g. the destination port field in the IP header).

Many of the embodiments described above are equally applicable to path back to the user from the application server. In many cases, this path will be similar to the upstream path to the server, whether direct or indirect. However, in many cases, the return path may be different from the forward path. Thus, all paths may be considered when computing the cost metric and selecting the server. Often, the upstream path and downstream path selection may be considered separately (e.g. one may find that different relay nodes are used for each) for path selection, and both may be considered for cost computation and server selection.

In other embodiments of the present invention, the use of relay nodes may have the effect of concentrating users' streams over a small number of paths. For applications in which low latency is achieved through the use of short packet payloads, packet overhead may be substantial (e.g. 50%). Since nearly all packets in each stream between two servers are likely to follow the same path (or paths, if multiple paths are defined between each server), redundant header information may be stripped and reinserted (if required) at the destination server.

In some embodiments, two servers and two users are provided. Other embodiments provide a system with N users and M servers (M>0, N>0 and M>1, N>1 for non-trivial cases).

In some embodiments, where a network with N>2 servers is provided, multiple relay nodes may be used to connect a user with a server. In such an embodiment, the user would address the first relay server, who would forward the packet to the next relay server, and so on until reaching the final destination server (and similarly in the reverse direction). Such embodiments provide scalability, as a direct connection between each pair of servers in a network with N servers would require N̂2 leased connections, which may be prohibitively large. In many embodiments, a multi-hop approach reduces the number of leased connections required. In such an embodiment, the cost incurred is that the multi-relay scenario would require some form of routing algorithm to be implemented (although a simple, static one may suffice for many systems).

In many embodiments, it may be more costly to route a specific user's traffic over a first path with shortest delay (or minimum cost, broadly defined) than over a second less direct path. If a second path is deemed sufficient, then it may be desirable to switch the path for this user from the first path to the second, once the determination has been made as to which server is to be used.

In many embodiments, it may be desirable to minimize bandwidth consumed on the network by dividing the mixing function between multiple servers, then combining these mixes at one server. For example, N users in close proximity to server A can be mixed at server A. M users close to server B can be mixed at B. These composite signals can be subsequently mixed at A, B or C forming a complete mix for distribution to at least any of N and M. In this manner, the bandwidth consumed on the network can be reduced. For example, the bandwidth between A and B can be reduced by a factor of N−1 if the mix is performed at B (mix bandwidth is equal to a single user's bandwidth).

In other embodiments, in a peer-to-peer collaboration system, mixes are done within each client using information received from all other clients. Each user may then transmit replicas of their content upstream destined for each other user. In some embodiments, this may require more upstream bandwidth than may be available over typical broadband connections (cable, DSL). In such an embodiment, each client may transmit a single copy of their content to the relay node server, which in turn replicates this content and sends it to each of the appropriate destinations. In many embodiments, IP multicasting techniques offer a convenient way to implement the replication. Transmission to the appropriate destinations may be done over direct (low-latency) links between servers, or through just best-effort Internet paths, or through a combination of both. If direct paths are utilized, at least part of the replication can be done at the egress relay node, to minimize link bandwidth.

While the foregoing is directed to embodiments of the present invention, other and further embodiments of the invention may be devised without departing from the basic scope thereof. It is understood that various embodiments described herein may be utilized in combination with any other embodiment described, without departing from the scope contained herein.

What is claimed is:

1. A system for processing data signals comprising:
a first data signal received from a first client;
a second data signal received from a second client;
a mixer for mixing the first and second data signals;
a first unique data mix, for the first client, generated by the mixer; and
a second unique data mix, for the second client, generated by the mixer,
wherein the selection of the mixer is chosen to give the best quality of service and least delay in processing the received first and second data signals.

2. A method of processing data signals comprising:
generating a first data signal from a first client;
generating a second data signal from a second client;
selecting the best, or better, location at which to mix the first and second data signals;
transmitting the first and second data signals to said mixer;
creating a first unique mix and a second unique mix;
sending the first unique mix to the first client; and
sending the second unique mix to the second client.
